(19) United States
(12) Patent Application Publication
(10) Pub. No.: US 2018/0207881 A1
(43) Pub. Date: Jul. 26, 2018

(54) METHOD FOR WELDING A POLYOLEFIN PLASTIC AND AN ADDITIONAL PLASTIC

(71) Applicant: Henkel AG & Co. KGaA, Duesseldorf (DE)

(72) Inventors: Pablo Walter, Munchen (DE); Norman Friedrich, Munchen (DE); Lina Gonzalez, Munchen (DE); Hendrik Luetzen, Munchen (DE); Thomas Haertig, Munchen (DE)

(21) Appl. No.: 15/934,090

(22) Filed: Mar. 23, 2018

Related U.S. Application Data
(63) Continuation of application No. PCT/EP2016/074659, filed on Oct. 14, 2016.

(30) Foreign Application Priority Data
Oct. 16, 2015 (EP) 15190203.8

(51) Int. Cl. B29C 65/40; C08L 23/06; C08F 10/02; C08L 23/08; C08F 210/16; C08L 35/00; C08F 22/06

(52) U.S. Cl. CPC B29C 65/405; C08L 23/06; C08F 10/02; C08L 23/0815; C08F 210/16; C08L 2207/068; C08F 22/06; C08F 2500/01; C08L 2207/04; C08L 2207/062; C08L 2207/064; C08L 35/00

(57) ABSTRACT

The invention relates to a method for welding a polyolefin plastic and a plastic consisting of a polymer with at least one aromatic unit in the polymer main chain, using a primer which contains at least one polymer built from at least one monomer with at least one double bond. The invention also relates to correspondingly welded products.

The present invention relates to a method for welding a polyolefin plastic and a plastic consisting of a polymer with at least one aromatic unit in the polymer main chain, using a primer which contains at least one polymer built from at least one monomer with at least one double bond. The present invention also relates to correspondingly welded products.

Various methods are known from the prior art for connecting two or more substrates to one another which consist of plastics, for example polyethylene (PE), polyacrylates, or polyamides (PA). Here, there are both mechanical connection possibilities, for example latching or screwing, and adhesive bonding methods. Alternatively, plastics can also be welded to one another. Welding is a joining method for the non-detachable, integrally bonded physical connection generally of plastics of the same type, for example PE to PE or PA to PA. Thermoplastics of the same type are polymers that do not differ significantly in terms of their molecular structure, their melting point, the melt viscosity and their coefficient of thermal expansion and which generally can be mixed with one another. Plastics of the same type are usually plastics having an identical polymer base or are identical plastics.

A wide range of methods are known for welding two or more plastics of the same type to one another. Here, a wide range of different welding methods can be employed, for example infrared welding, infrared/friction welding or ultrasonic welding. These methods for welding similar plastics are based on the fact that the plastics in question are melted in the region of the welding zone and the materials in this zone join to one another in an integrally bonded and frictionally engaged manner.

These welding methods work well, as long as the plastics connected to one another are plastics of the same type. However, as soon as it is attempted to weld together two plastics that are different or incompatible with one another, for example plastics formed from polypropylene and polycarbonate, it is not possible to produce a permanent connection of high mechanical strength between the two substrates. In the event that an attempt is made to directly weld the two plastics polypropylene and polycarbonate or the two plastics polypropylene and ABS (acrylonitrile-butadiene-styrene copolymer) using the welding methods known from the prior art, it will not be possible to attain any strength, or only very low strength will be attained.

Previously, corresponding different plastics could be connected to one another merely by a mechanical connection or an adhesive bonding method. The disadvantages of a mechanical connection are the complicated attachment, the material loading at specific points, and also the need for an additional mechanical connection means. Furthermore, integrally bonded connections can rarely be achieved in the case of a mechanical connection. The disadvantage of an adhesive bonding method, however, is that the end strength of the connection is achieved only after a long period of time, which can be up to several weeks. Furthermore, adhesive bonding of low-energy surfaces usually requires a complex pre-treatment of the joining partners. In addition, an adhesively bonded connection is often not indefinitely stable, on account of external weathering. Also, the provision of a clean adhesive bond is often complicated and time-consuming. The connection by means of a welding method, for plastics, thus constitutes the cleanest, quickest and simplest solution.

The object of the present invention thus lies in finding a simple method for welding a polyolefin plastic and a plastic selected from polycarbonate plastics and plastics formed from vinyl aromatic polymers. Here, the connection between these different plastics should be made as stable as possible by means of the weld seam and should be durable.

It has surprisingly been found that this object is achieved by a method for welding a polyolefin plastic and a second plastic containing a polymer with at least one aromatic unit in the polymer main chain, in particular selected from polycarbonate plastics and plastics formed from vinyl aromatic polymers, with use of a primer which contains at least one polymer built from at least one monomer with at least one double bond.

Due to the use of a primer containing at least one corresponding polymer, when welding a polyolefin plastic and a plastic selected from polycarbonate plastics and plastics formed from vinyl aromatic polymers, it has been possible to obtain particularly stable integrally bonded connections between the plastics.

The first joining partner for welding with use of a primer is a polyolefin plastic, in particular a thermoplastic polyolefin plastic. A polyolefin plastic is based on polyolefin polymers, such as homo- and copolymers of alpha olefins. The polyolefin polymers can be selected from the group consisting of poly-alpha-olefin homopolymers based on ethylene, propylene and/or butylene, in particular homopolymers formed from ethylene or propylene, and poly-alpha olefin copolymers based on ethene, propene, 1-butene, 1-hexene and 1-octene, in particular ethylene/alpha-olefin and propylene/alpha-olefin copolymers, preferably copolymers of ethylene or propene with 1-butene, 1-hexene, 1-octene, or a combination thereof. In particular, the polyolefin plastics are selected from polyethylene (in particular high-density/HD polyethylene, medium-density/MD polyethylene, low-density/LD polyethylene, ultra-high-molecular-weight/UHMW polyethylene and linear low-density/LLD polyethylene, preferably HD polyethylene, MD polyethylene or LD polyethylene) and polypropylene plastics. The polyolefin plastic is particularly preferably a polypropylene plastic.

The polyolefin polymers, in particular polypropylene polymers, preferably have a weight-average molar mass (weight-average Mw) of greater than 10,000 g/mol, in particular greater than 20,000 g/mol, preferably greater than 50,000 g/mol, particularly preferably greater than 100,000 g/mol. The polyolefin polymers, in particular polypropylene polymers, preferably have a weight-average molar mass (weight-average Mw) of less than 2,000,000 g/mol, in particular less than 1,000,000 g/mol, preferably less than 500,000 g/mol. Particularly preferred polyethylene polymers have a weight-average molar mass (weight-average Mw) of from 50,000 g/mol to 1,000,000 g/mol, in particular from 200,000 g/mol to 500,000 g/mol. Other preferred polyethylene polymers (UHMW-PE polymers) have a weight-average molar mass of greater than 2,000,000 g/mol, in particular of 4,000,000-6,000,000 g/mol. Particularly preferred polyolefin polymers, in particular polypropylene polymers, have weight-average molar masses (weight-average Mw) of 50,000 g/mol to 250,000 g/mol.

The polyolefin plastics, in particular polypropylene plastics, can also contain further components, for example fillers, such as glass fibers, pigments, dyes, rheology aids, mold release agents or stabilizers. The polyolefin plastic, in particular polyethylene and/or polypropylene plastic, preferably polypropylene plastic, preferably consists to an extent of more than 80 wt. %, in particular more than 90 wt. %, preferably more than 98 wt. %, of the aforesaid polyolefin polymers, in particular the aforesaid polyethylene and/or polypropylene polymers, preferably polypropylene polymers, in each case in relation to the polymer proportion of the polyolefin plastic (total polyolefin plastic without fillers). The polyolefin plastic, preferably polypropylene plastic, preferably consists to an extent of more than 50 wt. %, in particular more than 70 wt. %, preferably more than 90 wt. %, preferably more than 95 wt. %, particularly preferably more than 98 wt. %, of the aforesaid polyolefin polymers, in particular the polypropylene, in each case in relation to the total polyolefin plastic (with fillers).

The second joining partner for welding with use of a primer is a plastic that is based on a polymer with at least one aromatic unit in the polymer main chain, and the second plastic is selected in particular from polycarbonate plastics, plastics form from vinyl aromatic polymers, and mixtures thereof.

In a preferred embodiment, the second plastic is a polycarbonate plastic. Polycarbonate plastics are preferably thermoplastics, which can be described formally as polyesters of carbonic acid. Polycarbonates can be produced in principle by polycondensation of phosgene with diols, preferably bisphenols. Preferred polycarbonates are aromatic polycarbonate. Aromatic polycarbonates are those that are built at least from an aromatic monomer. Preferred polycarbonate plastics are bisphenol, in particular polycarbonate plastics based on bisphenol A and bisphenol F. In the case of the bisphenol-based polycarbonates, the diol component preferably consists to an extent of 50 wt. %, in particular 70 wt. %, preferably 90 wt. %, preferably 100 wt. % of bisphenol, in particular bisphenol A and/or bisphenol.

The polycarbonate plastics can also contain further components, for example fillers, such as glass fibers, pigments, mineral particles, dyes, rheology aids, mold release agents or stabilizers. The polycarbonate plastic preferably consists to an extent of more than 40 wt. %, in particular more than 60 wt. %, preferably more than 70 wt. %, preferably more than 90 wt. % of the aforesaid polycarbonates, in each case in relation to the entire polycarbonate plastic (with fillers). The polycarbonate plastic preferably consists to an extent of more than 90 wt. %, in particular more than 95 wt. %, preferably more than 98 wt. %, of the aforesaid polycarbonates, in each case in relation to the polymer proportion of the polycarbonate plastic (total plastic without fillers). The polycarbonate plastics preferably have a content of the aforesaid polycarbonates of 50-100 wt. %, in particular 90-100 wt. %, in each case in relation to the total polycarbonate plastic (with fillers).

In another preferred embodiment, the second plastic contains at least one vinyl aromatic polymer, in particular copolymer, formed from monomers selected from styrene, chlorostyrene, alpha-methylstyrene and para-methylstyrene. In minor proportions, the vinyl aromatic copolymers (preferably no more than 20 wt. %, particularly not more than 8 wt. %), also comonomers such as (meth)acrylonitrile or (meth)acrylic esters, may also be involved in the structure. Particularly preferred vinyl aromatic polymers are polystyrene, styrene-acrylonitrile copolymers (SAN), polystyrene methyl methacrylate (SMMA), and impact-modified polystyrene (HIPS=high impact polystyrene). It is understood that mixtures of these polymers can also be used.

Very particularly preferred vinyl aromatic polymers are ASA, ABS and AES polymers (ASA=acrylonitrile-styrene-acrylic ester, ABS=acrylonitrile-butadiene-styrene, AES=acrylonitrile-EPDM rubber-styrene). These impact-tough vinyl aromatic polymers contain at least one rubber-elastic graft polymer and a thermoplastic polymer (matrix Polymer). Generally, a styrene/acrylonitrile polymer (SAN) is used as matrix material. Graft polymers which, as rubber, contain a diene rubber based on dienes, such as butadiene or isoprene (ABS), an alkyl acrylate rubber based on alkyl esters of acrylic acid, such as n-butyl acrylate and 2-ethylhexyl acrylate, an EPDM rubber based on ethylene, propylene and a diene, or mixtures of these rubbers or rubber monomers, are preferred.

The weight-average molecular weight of these vinyl aromatic polymers is in particular from 1500 to 2,000,000 g/mol, preferably from 70,000 to 1,000,000 g/mol.

The second plastic is particularly preferably selected from SMMA, SAN, ASA, ABS and AES plastics, in particular ABS plastic.

The second plastic containing vinyl aromatic polymers, preferably the SMMA, SAN, ASA, ABS and AES plastic, can also contain further components, for example fillers, such as glass fibers, pigments, mineral particles, dyes, rheology aids, mold release agents all stabilizers. The second plastic, in particular the SAN, ASA, ABS and AES plastic, preferably consists to an extent of more than 40 wt. %, in particular more than 60 wt. %, preferably more than 70 wt. %, preferably more than 90 wt. % of the aforesaid vinyl aromatic polymers, in each case in relation to the total plastic (with fillers). The second plastic preferably consists to an extent of more than 90 wt. %, in particular more than 95 wt. %, preferably more than 98 wt. % of the aforesaid vinyl aromatic polymers, in particular SAN, ASA, ABS and/or AES polymers, in each case in relation to the polymer proportion of the plastic (total plastic without fillers). The second plastic preferably has a content of vinyl aromatic polymers of 60-100 wt. %, in particular 80-100 wt. %, in each case in relation to the total plastic (with fillers).

In another preferred embodiment, the second plastic contains a mixture of at least one polycarbonate and at least one vinyl aromatic polymer, preferably as mentioned above. This mixture preferably contains more of a polycarbonate than of the vinyl aromatic polymers, in particular SMMA, SAN, ASA, ABS and/or AES, preferably ABS. The ratio of polycarbonate, in particular of aromatic polycarbonate, to vinyl aromatic polymer, in particular SMMA, SAN, ASA, ABS and/or AES, preferably ABS, is preferably 1:1 to100:1, in particular 2:1 to 50:1, preferably 3:1 to 10:1.

The second plastic containing a mixture of at least one the carbonate and at least one vinyl aromatic Polymer can also contain further components, for example fillers, such as glass fibers, pigments, mineral particles, dyes, rheology aids, mold release agents, or stabilizers. The second plastic preferably consists to an extent of more than 40 wt. %, in particular more than 60 wt. %, preferably more than 70 wt. %, preferably more than 90 wt. % of the aforesaid mixture of at least one polycarbonate and at least one vinyl aromatic polymer, in each case in relation to the total plastic (with fillers). The second plastic preferably consists to an extent of more than 90 wt. %, in particular more than 95 wt. %, preferably more than 98 wt. % Of the aforesaid mixture of at least one polycarbonate and at least one vinyl aromatic polymer, in each case in relation to the polymer proportion of the plastic (total plastic without fillers). The second plastic preferably has a polymer content from the mixture of at least one polycarbonate and at least one vinyl aromatic polymer of 50-90 wt. %, in particular 60-80 wt. %, in each case in relation to the total plastic (with fillers).

A further essential aspect of the invention is the use of at least one primer, preferably precisely one primer. The primer contains at least a first polymer, which has been built from at least one monomer with at least one double bond.

The primer constitutes a welding aid, which is preferably applied as a pre-treatment layer to at least one of the surfaces to be welded of the substrates in the region of the joining zone. The primer is not to be understood to be an adhesive, cleaning agent or the like, rather the primer is an aid for welding, whereby the joining partners in the joining zone (or weld zone) are made compatible with one another, thus resulting, in the joining zone at the time of joining, in an integrally bonded and frictionally engaged connection between the substrates to be welded.

Tests have shown that, by use of a corresponding primer, containing a polymer according to the invention, the plastics to be joined can be made compatible at the time of welding in the joining seam, and therefore a stable and permanent connection can be attained. Without the use of a corresponding primer, no strength, or only very low strength of the welded connection could be attained. The joined substrates preferably have a tensile strength of more than 2 MPa, in particular more than 5 MPa, preferably more than 7 MPa. Tensile strength is determined by means of a pulling speed of 5 mm/s in accordance with the test procedure described in the tests.

The at least one polymer is a polymer built from at least one monomer with at least one double bond. Here, the double bond of the monomer(s), preferably a carbon-carbon double bond, is used to build the polymers, for example by radical or cationic polymerization. The polymers are thus synthesized with use of the double bond of the monomer(s). Suitable monomers are, for example, alpha-olefins, styrene and styrene derivatives, (meth)acrylic acid and derivatives thereof, such as (meth)acrylates or acrylonitrile, and maleic acid anhydride and derivatives thereof, and combinations thereof. Here, the polymer can be a homopolymer or copolymer. However, the primer is preferably substantially free from styrene-isoprene-styrene triblock copolymers (SIS), styrene-butadiene-styrene triblock copolymers (SBS) and/or styrene-ethylene/butadiene-styrene triblock copolymers (SEBS), in particular styrene-isoprene block copolymers (SI), styrene-butadiene-styrene block copolymers (SBS) and/or styrene-ethylene/butadiene-styrene block copolymers (SEBS), preferably substantially free from styrene-containing block copolymers, preferably substantially free from any block copolymers, particularly preferably substantially free from any phase-segregated block copolymers. Block copolymers are understood to mean polymers built from different segments/blocks formed from different monomers, wherein for example diblock copolymer (AB), triblock copolymers (ABA or ABC) or also multiblock copolymers (AnBm) fall under this definition. The term “substantially free from” is understood in accordance with the invention to mean that the primer contains less than 5 wt. %, preferably less than 1 wt. %, very particularly preferably less than 0.1 wt. % of the substances in question, and in particular does not contain the substances in question.

In a preferred embodiment the at least one polymer is constituted by polymers, in particular copolymers, which contain maleic acid anhydride groups reacted or polymerized into their chain. Here, a maleic acid anhydride or maleic acid anhydride derivative, in particular maleic acid anhydride can be reacted or polymerized into the polymer. An example of a maleic acid anhydride derivative is 1,2,3,6-tetrahydrophthalic acid anhydride, which comprises the relevant 5-membered anhydride group. Here, the polymers can contain the maleic acid anhydride groups both polymerized into the backbone, for example in a copolymer formed from at least one maleic acid anhydride monomer and acrylate and/or alpha-olefin monomers, and also grafted on, as in the case of maleic acid anhydride-grafted polyolefins. In a preferred form, the polymer in the primer is a maleic acid anhydride-grafted polyolefin, in particular a maleic acid anhydride-grafted polyethylene and/or maleic acid anhydride-grafted polypropylene, preferably a maleic acid anhydride-grafted polypropylene.

In another particularly preferred embodiment, the primer preferably contains a copolymer, which besides the maleic acid anhydride or maleic acid anhydride derivative also contains, polymerized therein, one or more monomers selected from the group of acrylates and methacrylates (together (meth)acrylates), in particular (meth)acrylates with an alkyl group having 1 to 12 carbon atoms, preferably 1 to 4 carbon atoms, preferably ethyl- and butyl(meth)acrylate, (meth)acrylic acid and alpha-olefins, in particular ethylene, propene, 1-butene, 1-hexene and 1-octene, preferably ethylene. Furthermore, functional monomers with functionalities such as epoxy or isocyanate groups, carboxyl or amino groups, but also alkoxysilane groups, can also be used. The at least one copolymer particularly preferably contains, polymerized therein, at least one maleic acid anhydride (derivative), a (meth)acrylate, and an alpha-olefin, preferably a maleic acid anhydride, a (meth)acrylate with a C1 to C4 alkyl group, and an ethylene or propylene.

The maleic acid anhydride group-containing polymers can be synthesized in the known manner from the monomers. In addition, these polymers can be grafted in a polymer-analogous reaction. Particularly preferred reaction partners for grafting are alcohols, thiols, amines, isocyanates, anhydrides, carboxylic acids, in particular alcohols, preferably alcohols having 1 to 6 carbon atoms, such as methanol and isobutanol. For grafting, the maleic acid anhydride monomers or maleic acid anhydride units in the polymer can be reacted with the reaction partner, in particular esterified by alcohols. The maleic acid anhydride groups preferably are reacted or esterified only in part, in particular less than 70% of the maleic acid anhydride groups. It is particularly preferred if the maleic acid anhydride groups are not converted and remain present as anhydride groups. In the preferred embodiment the maleic acid anhydride groups can also be present partially hydrolyzed. A complete conversion of the maleic acid anhydride groups can lead to a reduction of the strength of the resultant welded connection.

Polymers that contain a maleic acid anhydride content of greater than or equal to 0.001 wt. %, in particular greater than or equal to 0.01 wt. %, preferably greater than or equal to 0.02 wt. %, particularly preferably greater than or equal to 0.05 wt. % in relation to the polymer are particularly advantageous. The polymers advantageously contain a maleic acid anhydride content of 0.01-15 wt. %, in particular 0.02-10 wt. %, preferably 0.5-5 wt. %, in relation to the polymer. In another preferred embodiment the polymers contain a maleic acid anhydride content of 2-15 wt. %, in particular 5-10 wt. %, In relation to the polymer. Polymers with a corresponding maleic acid anhydride content have particularly good strengths of the welded connection.

In a further preferred embodiment the polymers according to the invention can be polyolefin polymers, such as homo- and copolymers of alpha-olefins. The preferred polyolefin polymers can be selected from the group consisting′ of poly-alpha-olefin homopolymers based on ethene, propene and/or butene, in particular homopolymers formed from ethylene or propylene, and poly-alpha-olefin copolymers based on ethene, propene, 1-butene, 1-hexene and 1-octene, in particular ethylene/alpha-olefin and propylene/alpha-olefin copolymers, preferably copolymers of ethene or propene with 1-butene, 1-hexene, 1-octene, or a combination thereof.

The polyolefin polymers can additionally also be functionalized, similarly to the above-mentioned grafted polyolefin polymers, or can be halogenated. The polyolefin polymers are preferably present in a halogenated, in particular chlorinated form. Chlorinated polyethylene polymers and/or chlorinated polypropylene polymers are particularly preferred, in particular chlorinated polypropylene polymers. The chlorinated polyolefins, in particular the chlorinated polyethylene polymers and/or chlorinated polypropylene polymers, preferably have a chlorine content of greater than 5 wt. %, in particular greater than 10 wt. %, preferably greater than 15 wt. %. The chlorinated polyolefins, in particular the chlorinated polyethylene polymers and/or chlorinated polypropylene polymers, preferably have a chlorine content of from 5 to 42 wt. %, in particular from 10 to 40 wt. %, preferably from 20 to 35 wt. %.

In a preferred embodiment these chlorinated polyolefin is, in particular the chlorinated polyethylene polymers and/or chlorinated polypropylene polymers, are grafted with maleic acid anhydride in the above-described manner. Here, the above-mentioned content of maleic acid anhydride is also particularly preferred.

In a further preferred embodiment the polymers according to the invention can be selected from copolymers which contain, as monomers polymerized therein, at least one (meth)acrylate, and at least one monomer selected from a styrene or styrene derivative and at least one further other (meth)acrylate. A copolymer of this kind can preferably contain, as first (meth)acrylate, monomers selected from the group of acrylates and methacrylates (together (meth)acrylates) with an alkyl group having 1 to 20 carbon atoms, preferably 10 to 20 carbon atoms, preferably stearyl acrylate. The further other (meth)acrylate, which is different from the first, is preferably selected from the group of acrylates and meth acrylates (together (meth)acrylates) with an alkyl group having 1 to 12 carbon atoms, preferably 1 to 4 carbon atoms, preferably methyl(meth)acrylate. Besides the styrene and (meth)acrylate, the copolymer can contain further monomers, such as acrylic acid, different (meth)acrylate monomers, in particular (meth)acrylates with an alkyl group having 10 to 20 carbon atoms, acrylonitrile, alpha-olefins, or dienes, such as butadiene. Furthermore, functional monomers with functionalities such as epoxy or isocyanate groups, carboxyl or amino groups, but also alkoxysilane groups, can also be used. Particularly preferred copolymers contain or are in particular synthesized from stearyl acrylate and methyl methacrylate or stearyl acrylate and styrene.

In a preferred embodiment the primer contains polymers selected from the group formed of
copolymers which contain maleic acid anhydride groups reacted or polymerized into their chain, in particular maleic acid anhydride-grafted polyolefins, preferably maleic acid anhydride-grafted polypropylene,
polyolefin polymers, in particular halogenated polyolefin polymers, preferably chlorinated polyethylene polymers and/or chlorinated polypropylene polymers, preferably chlorinated polypropylene,
maleic acid anhydride-grafted, chlorinated polyolefin polymers, in particular maleic acid anhydride-grafted, chlorinated polyethylene polymers and/or maleic acid anhydride-grafted, chlorinated polypropylene polymers, and
copolymers which contain, as monomers polymerized therein, at least one (meth)acrylate and at least one monomer selected from a styrene or styrene derivative and at least one further other (meth)acrylate, in particular copolymers containing, preferably synthesized from stearyl acrylate and methyl methacrylate or stearyl acrylate and styrene.

The above-mentioned polymers advantageously have a weight-average molecular weight Mw of greater than or equal to 5000 g/mol, in particular greater than or equal to 50,000 g/mol, preferably greater than 100,000 g/mol. The polymers preferably have a weight-average molar mass (weight-average Mw) in the range of 5,000-2,000,000 g/mol, in particular 50,000-1,000,000 g/mol, preferably 100,000-500,000 g/mol, Polymers with a corresponding weight-average molecular weight have a positive effect on the brittleness and strength of the obtained connection. The weight-average molecular weight can be determined by means of GPC in relation to a polystyrene standard.

Besides the polymer, the primer can also contain preferably at least one further polymer. The at least one further polymer or copolymer is preferably compatible with at least one of the two plastics to be welded and with the primer polymer. The primer particularly preferably contains at least one further polymer, on which one of the plastics to be joined is based, in particular a polyolefin polymer, such as a PE and/or PP polymer, and/or a vinyl aromatic polymer, such as SMMA, SAN, ASA, ABS and/or AES polymer, preferably in each case as specified above. The use of an additional polymer besides the (co)polymer according to the invention in the primer can lead to a further improvement of the strength.

A polymer that has a weighted, square distance of the Hansen parameters (Ra)² from one, in particular both of the plastics to be joined, and in particular also from the above-mentioned first polymer according to the invention of less than 22 MPa, in particular of less than 17 MPa, preferably of less than 15 MPa, particularly preferably of less than 12 MPa, is preferably used as compatible further polymer.

The weighted square distance of the Hansen parameters (Ra)² is determined in accordance with the following formula:

(Rₐ)²=4(Δδ_{D})²+(Δδ_{P})²+(Δδ_{H})²

In this formula δ_{D} is the Hansen parameter for dispersive force, δ_{P} is the Hansen parameter for polarity, and δ_{H} is the Hansen parameter for hydrogen bridge bonds. Δδ_{D}, Δδ_{P} and Δδ_{H} in each case represent the differences of these Hansen parameters of the plastics or polymers to be compared, for example Δδ_{D}=(δ_{D1}−δ_{D2}) of polymers 1 and 2. The values of the individual Hansen parameters δ_{D}, δ_{P} and δ_{H} are determined for the particular plastics or polymers in accordance with the book “Hansen Solubility Parameters: A User's Handbook”” by Charles M. Hansen (second edition; Taylor & Francis Group; 2007; ISBN-10 0-8493-7248-8). Many values of individual polymers can already been found in this source. In accordance with the method described in this book, the Hansen parameters can preferably be looked up with the HSPIP program (4th Edition 4.1.07) from the supplied database, or, if not provided, can be determined with the contained “DIY” functionality of the program, preferably with use of the supplied neural network, as described in the help section. The HSPIP program is obtainable from the company Steven Abbott TCNF Ltd.

The content of the further polymer, in particular a polyolefin polymer and/or a vinyl aromatic polymer, in the primer is preferably 1-40 wt. %, in particular 5-30 wt. %, particularly preferably 10-20 wt. %, in each case in relation to the total weight of the primer. The content of the further polymer in the polymer content of the primer is preferably 5-75 wt. %, in particular 30-70 wt. %, particularly preferably 40-65 wt. %, in each case in relation to the total polymer proportion of the primer (primer without solvents and without fillers).

Besides the copolymer and the further polymer, the primer can also contain a solvent, in particular an organic solvent. The primer preferably contains a solvent content of 10-90 wt. %, in particular 50-85 wt. %, particularly preferably 60-80 wt. %, in each case in relation to the total weight of the primer.

Suitable solvents are all conventional solvents, such as water, alcohols, ketones, such as methyl isobutyl ketone (MIBK) or cyclohexanone (CH), ethers, such as diethyl ether or tetrahydrofuran (THF), esters, such as ethyl acetate, or carbonates, such as dimethyl or dipropyl carbonate, xylene, toluene, or mixtures thereof.

In a preferred embodiment the primer contains organic solvents. Particularly preferred solvents are solvents with a vapor pressure at 20° C. of from 1 to 600 hPa, in particular 2 to 200 hPa, particularly preferably 5 to 20 hPa. Solvents having a corresponding vapor pressure have proven to be particularly advantageous for minimizing or preventing bubble formation in the primer layer during evaporation. The primer in particular preferably contains a solvent selected from tetrahydrofuran, methyl isobutyl ketone, cyclohexanone, and mixtures thereof, and the primer particularly preferably contains tetrahydrofuran or a mixture of methyl isobutyl ketone and cyclohexanone. If a mixture of methyl isobutyl ketone and cyclohexanone is used as solvent, this mixture preferably contains 10-50 wt. %, in particular 20-35% by weight, of cyclohexanone, in each case in relation to the total mixture of solvents.

When organic solvents are used, the total polymer content of the primer is preferably 10-90 wt. %, in particular 15-50 wt. %, particularly preferably 20-40 wt. %, in each case in relation to the total weight of the primer. The total polymer content corresponds to the content of all polymers used in the primer, in particular the polymers according to the invention and the above-described further polymers.

In another preferred embodiment the primer is present in the form of an aqueous dispersion or emulsion. In this case the polymer according to the invention or, if provided, the further polymers is/are emulsified or dispersed in water. In this case the total polymer content of the primer is preferably 2-90 wt. %, in particular 5-50 wt. %, particularly preferably 10-35 wt. %, in each case in relation to the total weight of the primer. For the aqueous dispersion/emulsion, it is advantageous that the polymer component consists substantially only of the polymer according to the invention and the optionally provided above-mentioned further polymers, in particular only of the polymer according to the invention. The term “consists substantially of” is understood in accordance with the invention to mean that the polymer component consists to an extent of more than 95 wt. %, preferably more than 97 wt. %, very particularly preferably more than 99 wt. % of the polymer according to the invention and the optionally provided, above-mentioned further polymer, in particular only of the polymer according to the invention.

Besides the polymer according to the invention, the above-mentioned further polymers and a solvent, the primer can also contain further components, such as fillers, (fluorescence) dyes and pigments, rheology aids, mold release agents, emulsifiers, surfactants, wetting agents, stabilizers or plasticizers. Apart from dyes, pigments and surfactants, however, the primer is preferably substantially free from further components, in particular substantially free from any other components. The term “substantially free from” is understood in accordance with the invention to mean that the primer contains less than 5 wt. %, preferably less than 1 wt. %, very particularly preferably less than 0.1 wt. % of the respective substances, and in particular does not contain the respective substances.

In the method according to the invention for welding a polyolefin plastic and a second plastic consisting of a polymer with at least one aromatic unit in the polymer main chain, a primer is used which contains at least one polymer built from at least one monomer with at least one double bond.

In a preferred method at least one of the plastics to be joined, in particular the second plastic, particularly preferably the polycarbonate plastic, is pre-treated with an amine-containing solution prior to the application of the primer. For pre-treatment, the surface of the plastic to be joined, in particular of the polycarbonate plastic, is preferably immersed in an amine-containing solution prior to the primer application. The plastic or the surface to be joined is preferably immersed in the amine-containing solution for 1 to 5000 seconds, in particular for 2 to 1800 seconds. The amine-containing solution preferably has a temperature of from 20° C. to 80° C., in particular 50° C. to 70° C.

In the amine-containing solution there is preferably an amine present in a solvent, in particular an organic solvent, preferably an alcohol, particularly preferably ethanol or isopropanol. In principle, all amines, in particular monomeric amines, are suitable. The amines are preferably selected from the group of diamines and functionalized amines. Aliphatic amines, such as 1-octylamine, hexylamine or ethylhexylamine, aliphatic diamines, such as 1,6-hexamethylenediamine or dodecanediamine, cycloaliphatic diamines, such as piperazine, N,N′-dimethylpiperazine or 2-piperazin-1-ylethylamine, polyamines such as triethylenetetramine, and functionalized amines, in particular hydroxy-functionalized amines, such as ethanolamine, are particularly preferred. However, amines such as polyethylene imine, in particular with a weight-average molecular weight of from 800 to 2,000,000 g/mol, can also be used.

The amine-containing solution preferably has an amine content of from 1 to 30 wt. %, in particular 2 to 20 wt. %, preferably 3 to 10 wt. %, in each case in relation to the total amine-containing solution.

The primer is used in the method according to the invention as an aid for the welding of the two different plastics by each being melted. Due to the used primer containing a polymer according to the invention, a compatibility between the two joining partners can be established, whereby a stable and durable integrally bonded connection between the two plastics can be produced.

The primer can be applied to the surface of one of the two joining partners by a wide range of methods. It can thus be applied for example by means of a metering device, by a needle and metering robot, by injection molding, by extrusion, by film application, by application as a hot melt, by spraying, by painting, or by dipping. Here, the primer can be applied either only to one surface or to both surfaces of the substrates to be welded.

Should the primer contain solvents, the primer is preferably dried following application to one or both surfaces until the solvent has evaporated to such an extent that a non-tacky, dimensionally stable primer layer is provided. In particular, the primer can be welded already after a few seconds and up to a number of weeks. The primer is preferably dried after application for at least one hour, preferably for at least 12 hours.

The primer is preferably applied to one or both surfaces of the substrates to be welded, in such a way that the primer has a layer thickness of from 1 μm to 5,000 μm, in particular 10-3,000 μm, preferably 50-1,000 μm, particularly preferably 100-500 μm. Layer thicknesses of greater than 100 μm are especially preferred. If a solvent was contained in the primer, the layer thickness relates to the primer dried of the solvent.

Following the application to one or both surfaces of the substrates to be welded and following the drying of the primer as appropriate, the substrates to be welded can be connected to one another by means of a conventional welding method. Plastics are welded generally by a local plasticization of the joining partners in the joining plane and are joined under pressure. The process parameters must be selected such that a marked compression-induced flow of the melt leads to an optimal connection of the joining partners in the joining plane. Heating can be provided by means of convection, contact heating, radiation or friction. The different energy application for plasticization can be provided in a wide range of ways and has led to various processes for welding plastics. Suitable welding methods are, for example:
hot gas welding [HG]

convective heating with a hot gas flow, generally air, two-step process
hot plate welding [HE]

contact heating, two-step process
ultrasonic welding [US]

heating by friction, a transverse wave in the ultrasound range leads to heating at the interface, one-step process
high frequency welding [HF]

heating by inner friction, polar molecules are oriented in accordance with a high-frequency magnetic field, one-step process, only used for polar plastics and films
friction welding [VIB] (Linear; Orbital; Spin; Angle)

heating by friction, one-step process
laser welding [LW] (contour, simultaneous, quasi-simultaneous, mask)

heating by radiation, radiation coherent, laser transmission welding, generally one-step process (two-step possible)
infrared welding [IR]

heating by means of radiation, radiation incoherent, two-step process

The above-mentioned methods can also be combined as appropriate, for example infrared welding and friction welding. The plastics are particularly preferably welded by a welding method selected from hot plate welding, heat-contact welding or heat-impulse welding, hot gas welding, microwave or induction welding, and combinations thereof, in particular selected from infrared welding, hot plate welding, friction welding, ultrasonic welding, and combinations thereof.

A method for joining the two plastics in an integrally bonded manner with use of the primer, said method containing the following steps
providing the first plastic having a first joining zone,
providing the second plastic having a second joining zone,
preheating the first joining zone,
applying the primer to the preheated first joining zone, in particular in the case of solvent-free primers,
bringing the first joining zone provided with a primer into contact with the second joining zone,
connecting the first joining zone and the second joining zone in an integrally bonded manner, in particular by use of conventional methods for welding plastics, such as infrared welding, hot plate welding, hot gas welding, friction welding, ultrasonic welding,

is particularly preferred.

The understanding of DIN 1910-3:1977-09 can be applied in general for the welding of plastics. Consequently, this can be understood to mean an integrally bonded connection of thermoplastics with the aid of heat and/or pressure. The heating can be provided for example on the basis of contact heating (welding by solid bodies), convection heating (welding by hot gas), radiation heating (welding by beam) and heating by friction (welding by movement) and welding by electric current.

In an advantageous development a primer is used that is selected and coordinated with the method in such a way that the application to a heated and/or hot joining zone at a temperature below the inner chemical cross-linking of the primer.

It is advantageous to pre-heat the first joining zone of the first plastic. Aids and techniques that are known to a person skilled in the art and are suitable for the proposed purpose can be used for the pre-heating. The use of hot gas or plasma is particularly suitable for the pre-heating. Pre-heating by means of irradiation, in particular infrared radiation or laser radiation, is also conceivable. A heating element or a heated tool can also be used in order to pre-heat the first joining zone. Lastly, pre-heating in a furnace or a heated space is also conceivable. Pre-heating of the entire plastic and therefore also said joining zone is conceivable. Alternatively or additionally, however, pre-heating merely of the joining zone itself is also possible.

In an advantageous development the distance of the heating device, during the pre-heating, from the plastic, in particular from the first joining zone to be pre-heated, in particular the heat-dissipating region of the heating device or the heat-releasing region of the heating device or the surface of the heating device effective for the pre-heating or the region of the heating device opposite the first joining zone, is in a range from 0.5 mm to 100 mm, preferably in the range from 1 mm to 60 mm. It is alternatively also conceivable for heating to be provided by and/or during contacting in particular of the first joining zone by the heating element of the heating device.

A further advantage is the selection of the plastic for the first adjoining partner and the setting of the method parameters in accordance with the first plastic, in such a way that the first joining zone is melted during the pre-heating and a melt layer is produced in the first joining zone during the pre-heating. The thickness of the melt layer in a preferred embodiment lies preferably in the range of from 0.05 mm to 6 mm, particularly preferably in the range of from 0.1 mm to 5 mm. a melt layer of this kind can lead to an improved adhesion and/or diffusion and/or interaction of the molecules and, in conjunction with a certain flow, can lead to an improved connection layer. If the interface of the first plastic is in the molten state, it can enter into interactions with the primer leading as far as the formation of chemical bonds. The melt layer can be dependent in particular on the component geometry and the particular component design. The method parameters are preferably set and/or selected in such a way that there is no deformation of the components. A compensation of temperature differences between the joining zone and the primer to be applied is preferably provided by suitable measures and/or method steps. Here, it is conceivable in particular to pre-heat the primer in order to reduce the temperature difference between the preferably thermoplastic primer and the first joining zone. This, for example, can counteract the rapid cooling of the first joining zone between the process steps.

There is optionally a pre-treatment of the first joining zone preferably before the step of pre-heating of the first joining zone. Alternatively or additionally, the second joining zone can also be pre-treated. For example, cleaning by means of a solvent or a plastic cleaner, which for example is alkaline, is conceivable as a possible pre-treatment. A mechanical pre-treatment can also be used, in particular by means of scratching, sanding, brushing or blasting. Conceivable chemical pre-treatments are in particular pickling or the use of reactive gases. In addition, the use of a thermal, chemical and/or physical pre-treatment has proven to be expedient, in particular by means of gas flame or plasma arc. Alternatively or additionally, an electrical pre-treatment by means of corona discharge can be provided, in which the first joining zone and/or the second joining zone are/is exposed to an electric corona discharge, so that polar molecules are produced on the corresponding surface. A further possibility is plasma treatment, preferably with use of a plasma nozzle for the pre-treatment of the joining zone, in particular in order to achieve an activation and/or cleaning of the corresponding surface. Likewise, coating by means of plasma can also prove to be expedient. A further possibility is the flame-treatment of the joining zone in order to increase the surface tension in suitable plastics. A further type of pre-treatment is irradiation by means of UV rays, electron beams, radioactive rays or by means of laser. Lastly, the pre-treatment can provided in the form of a coating, in particular by a paint or an adhesion promoter. A pre-treatment of the first plastic or the joining zones of the first plastic at an even earlier time before the pre-heating is also conceivable. For example, it is conceivable to carry out the pre-treatment already within the scope of the manufacturing process of the first plastic, so as to be able to further process the pre-treated plastic in the method according to the invention.

It is conceivable to apply the primer in different ways. For example and in particular in the industrial field, application by means of an automated application aid, in particular by means of a metering robot, is conceivable. Said robots can be equipped with a needle and/or a height sensor so as to be able to perform complex metering operations. The primer can also be applied by means of injection molding, in that the primer is plasticized in an injection molding machine and is injected under pressure into the mold containing the first plastic with the first joining zone. Alternatively, application in the form of a film is conceivable, wherein, in a first step, a film is firstly produced from the primer by means of film blowing or flat film extrusion. The film can then be cut into any form, for example by means of a cutting or punching method, and in a further step can be applied to the first joining zone following the aforesaid pre-heating. Here, the use of films/plates with a thickness in the range of from 1 μm-5,000 μm has proven to be expedient. Further conceivable application possibilities are extrusion welding, in which the primer is present in the form of a welding wire or is melted in an extruder and can be applied in melt form to the first joining zone. It is also possible to provide the primer in the form of a welding wire in order to enable application by means of hot air welding. A further possibility is application of the primer by means of a spraying method. Even when applying the primer within the scope of injection molding, a pre-treatment and/or pre-heating and/or locally different temperature control of the injection mold is/are possible. Of course, all other application methods known to a person skilled in the art and suitable for the specific application are also conceivable.

A further advantage is the further heating or heating of the first joining zone during the application of the primer, in particular in order to avoid a temperature drop of the first joining zone between the pre-heating and the application of the primer. This can be implemented by the above-described method step for pre-heating, which for the sake of simplicity can be continued during the application. Alternatively or additionally, an additional heating, in particular by means of a further method step, is possible. For example, it can thus prove to be expedient to carry out a simultaneous heating of the first joining zone, for example by means of simultaneous irradiation of the first joining zone with radiation, forced convection, or contact heating during the application, in order to avoid a temperature drop of the first joining zone after the pre-heating.

In an advantageous development the primer is applied in such a way that a connection layer having a thickness in the range of from 1 μm to 5 mm, preferably in the range of from 10 μm to 3 mm, is arranged on the first joining zone. Here, the thickness of the connection layer is understood to mean the material thickness of the connection layer on the first joining zone.

A further advantage is the application of the primer by means of a metering device to the first joining zone with relative movement between first joining zone and the metering device, wherein the first joining zone, to which the primer is applied, is pre-heated by means of a heating device prior to the application of the primer, with relative movement between first joining zone and heating device, wherein the primer is applied by means of the metering device in the pre-heated state of the first joining zone.

Here, it has proven to be particularly advantageous that the heating device at the time of the pre-heating is guided past the first joining zone at a speed in the range of from 10 mm/min to 100 m/min, preferably in the range of from 10 mm/min to 30 m/min.

It can also be advantageous that the heating device of the metering device runs ahead preferably at a defined and constant distance. In particular, it is advantageous to carry out the method in such a way that primer is applied by means of a metering device to the first joining zone with relative movement of the metering device and first joining zone in the range of from 10 min/min to 100 m/min, preferably in the range of from 10 mm/min to 30 m/min, wherein said joining zone, to which the primer is applied, is pre-heated by means of a heating device prior to the application of the primer, with relative movement of the heating device and first joining zone, wherein the heating device of the metering device or of a nozzle of the metering device for application of the primer runs ahead, preferably simultaneously, by a time in the range of 0.1-10 s.

Here, it has proven to be particularly advantageous to use a coating unit consisting of a metering device and heating device. Here, a coating unit can be understood in particular to mean a unit that provides a fixed connection of heating device and metering device, so that the heating device runs ahead of the metering device preferably at a defined and constant distance during the relative movement, in order to ensure that the first joining zone is pre-heated immediately prior to the application of the primer. Of course, it is also conceivable for the distance to be adjustable or, in the case of convective pre-heating, to be able to adjust the volume flow or nozzle diameter of the medium, in particular by suitable mechanical, electromechanical also pneumatically operating adjustment means.

On the other hand, the coating unit can also be understood to mean a heating device and a metering device in the form of two completely separate or separated modules, which, however, perform the same or substantially the same movement relative to the plastic in order to ensure that the point at which the primer is to be applied is pre-heated immediately prior to the application of the primer.

In an advantageous development the heating device and metering device perform substantially the same primary movement relative to the plastic or move in substantially the same basic direction relative to the plastic, but at least one of both aforesaid devices, in addition to said primary relative movement, also experiences an additional movement relative to the plastic. For example, the heating device and/or the metering device can perform one or more secondary relative movements in addition to the primary relative movement, in which for example the primer can also be applied. For example, the heating device and/or the metering device can perform or experience a secondary relative movement that orbits around the primary relative movement or is a meandering movement.

Here, the plastic can be moved on the one hand, or the heating device and metering device or both devices can be moved together as coating unit on the other hand. It is possible here that the heating device and metering device or both devices together as coating unit are stationary on the one hand or that the plastic is stationary on the other hand or in each case are/is moved with the moving part in a different direction.

In an advantageous development a primary relative movement is performed at a speed in a range of from 10 mm/min to 100 m/min, preferably in the range of from 10 mm/min to 30 m/min, and therefore, for example, the shortest possible residence times of the plastic within the heating area of the heating device are provided, in particular also by suitable design of the heating device, said residence times lying in a range of 1-60 s. The heating area can be understood to mean the region or the space around the heating device that has an influence on the temperature in the sense of a temperature increase, i.e. a pre-heating of the first joining zone of the first plastic. For example, excessive heating and damage to the plastic or an adverse effect on the plastic can thus be avoided.

In addition, it can prove to be advantageous, in particular for the connection of the metering device and/or the heating device to/in existing manufacturing lines, to equip the heating device with a bus interface, in particular a Profibus or a real-time Ethernet interface.

Once said primer has been applied, it is provided to bring the second joining zone into contact with the primer layer. Here, a fixing of both plastics to one another can prove to be expedient, in particular by means of clamping devices known to a person skilled in the art or similar fixing aids.

Of course, prior to the step of bringing the second joining zone into contact with the primer layer, a pre-treatment of the second joining zone can be performed optionally. In particular all of the above-described techniques for a pre-treatment are conceivable here. A pre-treatment of the second plastic or of the joining zones of the second plastic at an even earlier time prior to the contacting is also conceivable. For example, it is thus conceivable to perform the pre-treatment already within the scope of the manufacturing process of the second plastic, so as to be able to further process a pre-treated plastic in the method according to the invention. The pre-treatment of the second plastic can also include the application of the primer to the second joining zone. Here, a pre-heating of the second joining zone prior to the application of the primer is preferably also conceivable. The details provided above are likewise preferred at this juncture.

The above-described contacting of second joining zone and primer is followed by a joining process, in which the treated and/or coated adjoining partners are plasticized by feeding heat and are connected to one another in an integrally bonded manner, preferably under the action of pressure. The use of a supply of heat by means of heat conduction, for example by means of hot plate welding and/or heat contact welding and/or heat impulse welding; by friction, in particular ultrasonic, friction or high frequency welding; microwave or induction welding; by convection, for example hot gas welding; by means of radiation, for example infrared, laser butt welding or laser transmission welding or also by a combination of two or more of these techniques, is conceivable for this integrally bonded connection of the second joining zone with the primer.

A further subject of this invention is constituted by articles or products produced in accordance with the method according to the invention.

An additional subject of this invention is the use of a primer according to the invention for welding a polyolefin plastic and a plastic selected from polycarbonate plastics and plastics formed from vinyl aromatic polymers.

### PRACTICAL EXAMPLES

Used Materials and Abbreviations:

PP=polypropylene

PC=polycarbonate

ABS=acrylonitrile-butadiene-styrene

MAH=maleic acid anhydride

MIBK=methyl isobutyl ketone

CH=cyclohexanone

THF=tetrahydrofuran

PP-MAH=PP-MAH with MFR (230° C.; 2.16 Kg)=7-12

Chlorinated/modified primer polymers:

Primer polymer 1=polypropylene; 20.5% chlorine content; MAH modified; Mw=70,000 g/mol

Primer polymer 2=polypropylene; 22% chlorine content; MAH modified; Mw=60,000 g/mol

primer polymer 3=polypropylene; 15% chlorine content; MAH modified; Mw=110,000 g/mol

Primer polymer 4=polypropylene; 32% chlorine content; Mw=˜100,000 g/mol

Primer polymer 5=polyolefin; acrylate- and MAH modified; Mw=67,500 g/mol

IR: infrared welding; IR-VIB: infrared/friction welding; US: ultrasonic welding

Hot plate welding of PP-PC and PP-ABS with modified polyolefins (primer polymers 1-5:

At 280° C., PP was melted for 20 s and PC was melted for 40 s or ABS was melted for 20 s over the area of 30 mm×4 mm on the hot plate, both plastics to be joined were immersed in a melt of the primer polymer, and the primer-coated polymers were joined under slight pressure. After 24 hours at room temperature, the welded samples were examined in a tensile testing machine with a test speed of 5 mm/s at room temperature. The polymer combinations and the used primer polymer are shown in the following tables with the associated tensile strengths.

| Polymer 1 | Polymer 2 | Primer polymer | Tensile strength in MPa |
|---|---|---|---|
| PP | PC | 5 | 2.12 |
| Hostacom | Makrolon | 1 | 3.34 |
| M4N01 | AL2447 | 2 | 3.35 |
| | | 3 | 4.66 |
| | ABS | 5 | 5.7 |
| | Starex | 1 | 6.99 |
| | SD0150 | 2 | 6.39 |
| | | 3 | 7.57 |

Good strengths of the welded samples could be obtained with the stated primer polymers. Without primer, the samples welded by heating element had no strength and fell apart from one another directly after the welding.

Production of Primers 1-3

In order to produce the primers, the primer components were mixed by mechanical stirring in solvent, dissolved at 90° C., and then degassed at 25° C. The composition of the primers is detailed in the following table in g.

| | Primer | | |
|---|---|---|---|
| | 1 | 2 | 3 |
| Primer polymer 4 | 35.00 | 42.00 | 28.00 |
| ABS-TX-0510T | 35.00 | 28.00 | 42.00 |
| Disperbyk-168 | 4.00 | 4.00 | 4.00 |
| THF | 104.00 | 104.00 | 104.00 |
| CH | 26.00 | 26.00 | 26.00 |

The primers were applied at room temperature to the surface (130 mm×3 mm) of the PP plastic to be welded. The primer was then dried of the solvent for 24 hours at room temperature. After drying, the thickness of the primer was approximately 0.2 mm. The pre-dried plastic components with a geometry of 130 mm×68 mm×3 mm were then butt-welded to the 130 mm×3 mm surface. The tensile strength was determined at a pulling speed of 5 mm/s at room temperature. Each combination of primer with the used plastics and the welding method and the ascertained tensile strengths (in MPa) is specified in the following table.

| | | | Welding | Tensile strength |
|---|---|---|---|---|
| Polymer 1 | Polymer 2 | Primer Nr. | method | MPa |
| PP Moplen | PC Makrolon | 1 | IR | 7.07 |
| HP501L | AL2447 | | IR/VIB | 10.3 |
| PP Moplen | PC Makrolon | 2 | IR | 10.19 |
| HP501L | AL2447 | | IR/VIB | 9.51 |
| PP Moplen | PC Makrolon | 3 | IR | 8.03 |
| HP501L | AL2447 | | IR/VIB | 8.42 |
| PP Hostacom | PC Makrolon | 1 | IR | 6.32 |
| M4N01 | AL2447 | | IR/VIB | 7 |
| PP Hostacom | PC Makrolon | 2 | IR | 9.94 |
| M4N01 | AL2447 | | IR/VIB | 7.09 |
| PP Hostacom | PC Makrolon | 3 | IR | 7.4 |
| M4N01 | AL2447 | | IR/VIB | 8.42 |
| PP Moplen | PC Makrolon | — | IR | 0.2 |
| HP501L | AL2447 | | IR/VIB | 0 |
| PP Hostacom | PC Makrolon | — | IR | 0.84 |
| M4N01 | AL2447 | | IR/VIB | 0 |
| PP white, 20% | ABS Starex | 1 | IR | 12.04 |
| mineral-filled | SD0150 | | IR/VIB | 12.15 |
| PP white, 20% | ABS Starex | 2 | IR | 9.94 |
| mineral-filled | SD0150 | | IR/VIB | 7.09 |
| PP white, 20% | ABS Starex | 3 | IR | 6.62 |
| mineral-filled | SD0150 | | IR/VIB | 7.86 |
| PP white, 20% | ABS Starex | — | IR | 2.63 |
| mineral-filled | SD0150 | | IR/VIB | 2.63 |

Excellent strengths of the welded PP-PC and PP-ABS plastics were obtained with primer. Without primer, only low or no strength of the welded plastics was obtained.

Production of the copolymers containing stearyl acrylate and styrene or methyl methacrylate:

The following table states the used monomer amounts in grams.

| Primer Polymer | Stearyl | | Methyl | Dibenzoyl peroxide |
|---|---|---|---|---|
| Nr. | acrylate | Styrene | methacrylate | Luperox A75 |
| 6 | 30.2 | — | 20.14 | 0.1045 |
| 7 | 15 | — | 35 | 0.1037 |
| 8 | 16.5 | 38 | — | 0.2078 (in 2 portions) |
| 9 | 10 | 40 | — | 0.208 (in 2 portions) |

Copolymers of stearyl acrylate, styrene and methyl methacrylate in accordance with the above table were synthesized by radical polymerization. All reactants and the initiator were weighed into a 1 L 2-neck flask and heated in an oil bath under vigorous stirring by means of a magnetic stirrer within 30 min to 95° C. oil bath temperature. After a short period of time, a second portion was added in part to the initiator. Once a solid mass had been produced, the mixture was heated for 5 hours to 150° C. After cooling to 20° C., colorless solids were obtained. The primer polymer nos. 8 and 9 were produced as 20 wt. % solution in THF by stirring in solvent at 20° C. and, as described beforehand, were applied to the area of 130 mm×3 mm to PP and welded with PC. Primer polymers 6 and 7 were used as solids for hot plate welding as described above. The joining part combination PP Hostacom M4N01 and PC Makrolon AL2447 was used. The tensile strengths at room temperature and a test speed of 5 mm/s, the used primer polymer, and the welding method are presented in the table below.

| Primer | | Tensile strength |
|---|---|---|
| Polymer Nr. | Welding method | MPa |
| 6 | Hot plate welding | 2.30 |
| 7 | Hot plate welding | 1.31 |
| 8 | IR/VIB | 5.08 |
| 9 | IR | 4.96 |

Good strengths of the welded samples were obtained with primer polymers.

Amine Pre-Treatment of PC:

The used amines and concentration thereof in isopropanol are stated in the following table. PC Makrolon AL2447 plates of 130 mm×68 mm×3 mm were immersed into the amine solution under the conditions (time and temperature) stated in the table and then left to dry off the solvent residue at room temperature for 24 hours. By means of a hand extruder (Alpha 2; Wegener International GmbH), a PP-MAH with a MFR=7-12(230° C.; 2.16 Kg) at 230° C. melt temperature was extruded onto the amine-treated PC plates pre-heated by hot gas at 280° C. for 15 seconds. After 24 hours a qualitative assessment of the adhesion was performed by peeling off the extrudate. The assessment is also included in the table below.

| | PC immersion | |
|---|---|---|
| | time and | Qualitative |
| | temperature of | adhesion |
| Concentration and amine in isopropanol | the solution | assessment |
| 3 wt. % 1,12-dodecanediamine | 2 sec; 65° C. | 2 |
| 3 wt. % 1,12-dodecanediannine | 10 min; 65° C. | 1 |
| 10 wt. % 1,12-dodecanediamine | 10 min; 65° C. | 2 |
| 10 wt. % 1,12-dodecanediamine | 30 min; 65° C. | 1 |
| 3 wt. % 1,6-hexamethylendiamine | 2 sec; 65° C. | 2 |
| 3 wt. % 1,6-hexamethylendiamine | 10 min; 65° C. | 1 |
| 10 wt. % 1,6-hexamethylendiamine | 2 sec; 65° C. | 2 |
| 10 wt. % 1,6-hexamethylendiamine | 10 min; 65° C. | 2 |
| 3 wt. % ethanolamine | 10 min; 65° C. | 3 |
| 3 wt. % ethanolamine | 30 min; 65° C. | 2 |
| 10 wt. % ethanolamine | 10 min; 65° C. | 2 |
| 3 wt. % 2-piperazin-1-ylethylamine | 2 sec; 20° C. | 1 |
| 3 wt. % 2-piperazin-1-ylethylamine | 2 sec; 65° C. | 1 |
| 3 wt. % 2-piperazin-1-ylethylamine | 10 min; 65° C. | 2 |
| 3 wt. % 2-piperazin-1-ylethylamine | 30 min; 65° C. | 2 |
| 10 wt. % 2-piperazin-1-ylethylamine | 2 sec; 20° C. | 2 |
| 10 wt. % 2-piperazin-1-ylethylamine | 2 sec; 65° C. | 1 |
| 10 wt. % 2-piperazin-1-ylethylamine | 10 min; 65° C. | 2 |
| 10 wt. % 2-piperazin-1-ylethylamine | 30 min; 65° C. | 2 |
| Without pre-treatment | — | 3 |
| Isopropanol | 2 sec; 20° C. | 3 |

1 = Extrudate cannot be peeled away from the PC,
2 = Extrudate can be peeled away from the PC with medium force applied,
3 = Extrudate separates from the PC without significant force applied.

Excellent adhesion of the PP-MAH to the PC was attained with many amine pre-treatments. Reference tests without pre-treatment or with pre-treatment with pure isopropanol revealed no adhesion of the extrudate on the PC.

What is claimed is:

1. A method for welding a polyolefin plastic and a second plastic containing a polymer with at least one aromatic unit in the polymer main chain, using a primer which contains at least one polymer built from at least one monomer with at least one double bond.

2. The welding method according to claim 1, characterized in that the polyolefin plastic is selected from the groups of polyethylene plastic, in particular HD polyethylene, MD polyethylene, LD polyethylene, UHMW polyethylene, or LLD polyethylene plastic, and polypropylene plastic, preferably is a polypropylene plastic.

3. The welding method according to claim 1, characterized in that the polyolefin plastic contains a polyolefin polymer, in particular a polyethylene and/or polypropylene to an extent of more than 90 wt. %, in each case in relation to the total polyolefin plastic, and/or the polyolefin plastic has molar masses (weight-average Mw) of greater than 10,000 g/mol.

4. The welding method according to claim 1, characterized in that the second plastic is selected from polycarbonate plastics and plastics formed from vinyl aromatic polymers, in particular the second plastic is a polycarbonate plastic formed from a bisphenol, in particular is a polymer containing bisphenol A and/or bisphenol F, or the second plastic is selected from SMMA, SAN, ASA, ABS and AES plastics, in particular is an ABS plastic, or the second plastic is formed from a mixture of a polycarbonate and a vinyl aromatic polymer.

5. The welding method according to claim 1, characterized in that the at least one polymer of the primer is selected from the group of:
copolymers which contain maleic acid anhydride groups reacted or polymerized into their chain, in particular maleic acid anhydride-grafted polyolefins, preferably maleic acid anhydride-grafted polypropylene,
polyolefin polymers, in particular halogenated polyolefin polymers, preferably chlorinated polyethylene polymers and/or chlorinated polypropylene polymers, preferably chlorinated polypropylene,
maleic acid anhydride-grafted, chlorinated polyolefin polymers, in particular maleic acid anhydride-grafted, chlorinated polyethylene polymers and/or maleic acid anhydride-grafted, chlorinated polypropylene polymers, and
copolymers which contain, as monomers polymerized therein, at least one (meth)acrylate and at least one monomer selected from a styrene or styrene derivative and at least one further other (meth)acrylate, in particular copolymers containing, preferably synthesized from stearyl acrylate and methyl methacrylate or stearyl acrylate and styrene.

6. The welding method according to claim 1, characterized in that the at least one polymer has a weight-average molecular weight Mw in the region of 5,000-2,000,000 g/mol, in particular from 50,000-1,000,000 g/mol, preferably of 100,000-500,000 g/mol.

7. The welding method according to claim 1, characterized in that the primer, besides the polymer built from at least one monomer with at least one double bond, also contains at least one further polymer, which is compatible with at least one of the two plastics to be welded, preferably at least one polyolefin polymer, such as a PE and/or PP polymer, and/or at least one vinyl aromatic polymer, such as a SMMA, SAN, ASA, ABS and/or AES polymer.

8. The welding method according to claim 1, characterized in that the primer contains at least one solvent, in particular at least one organic solvent, wherein the primer preferably has a solvent content of 10-95 wt. %, in particular 50-90 wt. %, particularly preferably 70-85 wt. %, in each case in relation to the total weight of the primer.

9. The welding method according to claim 8, characterized in that the at least one solvent has a vapor pressure at 20° C. of from 1 to 600 hPa, in particular 2 to 200 hPa, particularly preferably 5 to 20 hPa, and the solvent is preferably selected from the group of tetrahydrofuran, methyl isobutyl ketone, cyclohexanone, and mixtures thereof.

10. An article produced by a welding method according to claim 1.
